(19) United States
(12) Patent Application Publication
(10) Pub. No.: US 2012/0050905 A1
(43) Pub. Date: Mar. 1, 2012

(54) SOC HARDWARE ENGINES FOR MULTI-RATE NOTCH FILTERS

(75) Inventors: Tao Zhang, San Ramon, CA (US); Chang-Ik Kang, Santa Clara, CA (US); BongJin Lee, Fremont, CA (US)

(73) Assignee: Samsung Electronics Co., Ltd., Suwon City (KR)

(21) Appl. No.: 12/870,182

(22) Filed: Aug. 27, 2010

(51) Int. Cl. G11B 5/09

(52) U.S. Cl. 360/39; G9B/5.033

(57) ABSTRACT

A hard disk drive that includes a disk with servo bits. The hard disk drive also includes a central processing unit that performs a servo routine using the servo bits, and a separate a notch hardware engine that is utilize by the central processing unit to perform a notch filter function in the servo routine. Off-loading the notch filter function onto a hardware engine reduces the overhead on the central processing unit when performing a servo routine. Utilizing the notch hardware engine can improve the speed of the central processing unit by a factor of 10×.

### BACKGROUND OF THE INVENTION

1. Field of the Invention

The present invention relates to a servo routine of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

Information is typically stored in radial tracks that extend across the surface of each disk. Each track is typically divided into a number of segments or sectors. The voice coil motor and actuator arm can move the heads to different tracks of the disks.

FIG. 1 shows a typical track that has a number of fields associated with each sector. A sector may include an automatic gain control (“AGC”) field 1 that is used to adjust the strength of the read signal, a sync field 2 to establish a timing reference for the circuits of the drive, and ID 3 and Gray Code 4 fields to provide sector and track identification.

Each sector may have also a servo field 5 located adjacent to a data field 6. The servo field 5 contains a plurality of servo bits A, B, C and D that are read and utilized in a servo routine to position the head 7 relative to the track. By way of example, the servo routine may utilize the algorithm of ((A−B)−(C−D)) to create a position error signal (“PES”). The PES is used to create a drive signal for the voice coil motor to position the head on the track. The servo bits are used to perform a servo routine within the disk drive. By way of example, the servo routine can be used to center the heads on the tracks. As disk capacity increases the number of servo samples also increases. The servo routines are typically performed by a central processing unit (“CPU”). Higher sample rates increases the overhead on the CPU. It is desirable to lower the load on the CPU caused by higher servo sample rates.

### BRIEF SUMMARY OF THE INVENTION

A hard disk drive that includes a disk with servo bits. The hard disk drive includes a central processing unit that performs a servo routine using the servo bits, and a separate a notch hardware engine that is utilize by the central processing unit to perform a notch filter function in the servo routine.

### BRIEF DESCRIPTION OF THE DRAWINGS

FIG. 1 is an illustration of a track of the prior art;

FIG. 2 is a top view of an embodiment of a hard disk drive;

FIG. 3 is a schematic of an electrical circuit for the hard disk drive; and,

FIG. 4 is a flowchart showing a notch filtering process.

### DETAILED DESCRIPTION

Described is a hard disk drive that includes a disk with servo bits. The hard disk drive also includes a central processing unit that performs a servo routine using the servo bits, and a separate a notch hardware engine that is utilize by the central processing unit to perform a notch filter function in the servo routine. Off-loading the notch filter function onto a hardware engine reduces the overhead on the central processing unit when performing a servo routine. Utilizing the notch hardware engine can improve the speed of the central processing unit by a factor of 10×.

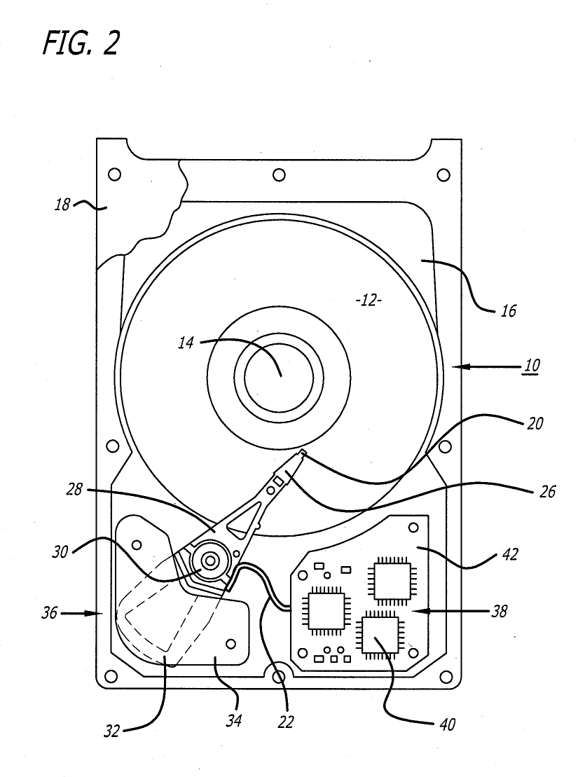

Referring to the drawings more particularly by reference numbers, FIG. 2 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write and read elements. The write element magnetizes the disk 12 to write data. The read element senses the magnetic fields of the disks 12 to read data. By way of example, the read element may be constructed from a magneto-resistive material that has a resistance which varies linearly with changes in magnetic flux.

Each head 20 may be gimbal mounted to a suspension arm 26 as part of a head gimbal assembly (HGA). The suspension arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes one or more integrated circuits 40 coupled to a printed circuit board 42. The printed circuit board 40 is coupled to the voice coil 32, heads 20 and spindle motor 14 by wires (not shown).

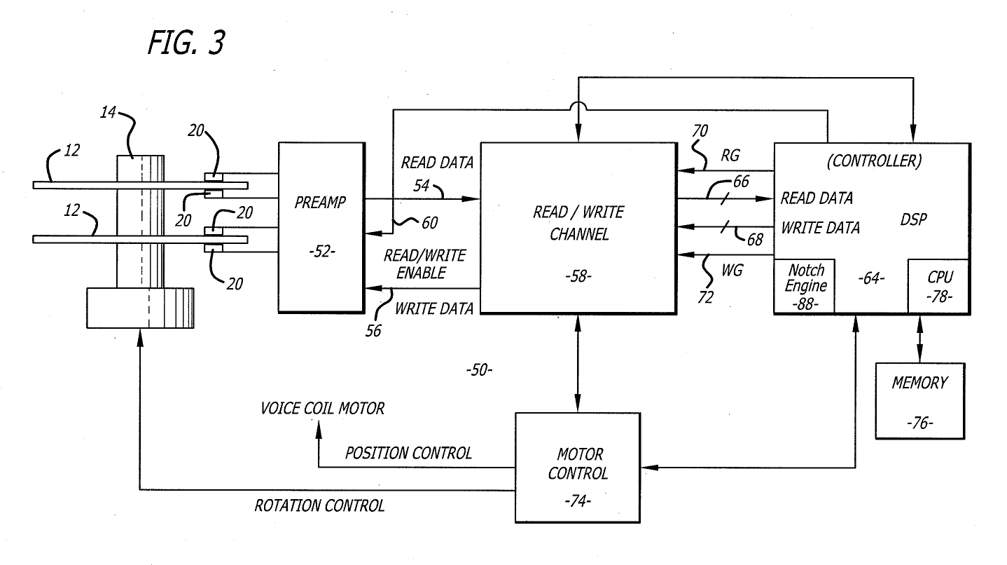

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read-only memory (“ROM”) that contains instructions that are read by the controller 64.

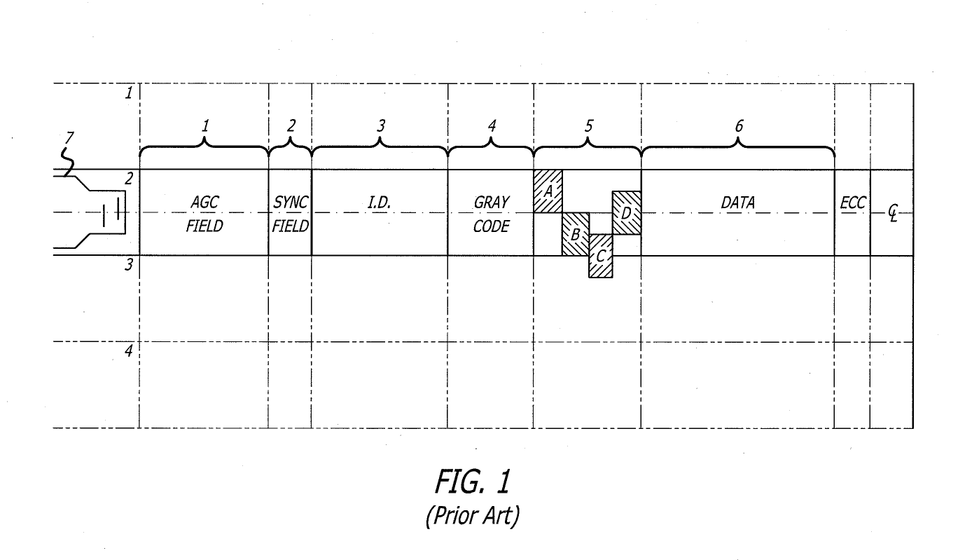

The controller 64 includes a central processing unit (“CPU”) 78. The CPU 78 performs software routines in accordance with data and instructions. The CPU 78 can perform a servo routine utilizing the A, B, C and D servo bits shown in FIG. 1. The servo routine includes one or more notch filter functions. The notch filter functions are performed by a notch hardware engine 80 that is separate from the CPU 78. By way of example, the notch hardware engine 80 may include a transfer function of the form:

$$\begin{matrix}Transfer Function \text{:} \\ \frac{y ( z )}{u ( z )} = \frac{{b}_{0} + {b}_{1} {z}^{- 1} + {b}_{2} {z}^{- 2}}{1 + {a}_{1} {z}^{- 1} + {a}_{2} {z}^{- 2}} & ( 1 ) \\ Calculation \text{:} \\ y ( k ) = - {a}_{1} y ( k - 1 ) - {a}_{2} y ( k - 2 ) + {b}_{0} u ( k ) + {b}_{1} u ( k - 1 ) + {b}_{2} u ( k - 2 ) & ( 2 )\end{matrix}$$

where,

y(k)=the transfer function.

u(k)=is a 32 bit input variable.

a₁, a₂, b₀, b₁ and b₂=Q14 filter parameters.

The notch hardware engine 80 may be an application specific integrated circuit (“ASIC”) with add and multiplication elements that perform the stated calculation. By way of example, the notch hardware engine 80 may have known Boolean operators to perform the transfer function calculation. The hardware engine 80 may be on board the same chip as the CPU 78. Alternatively, the hardware engine 80 may be on a separate chip.

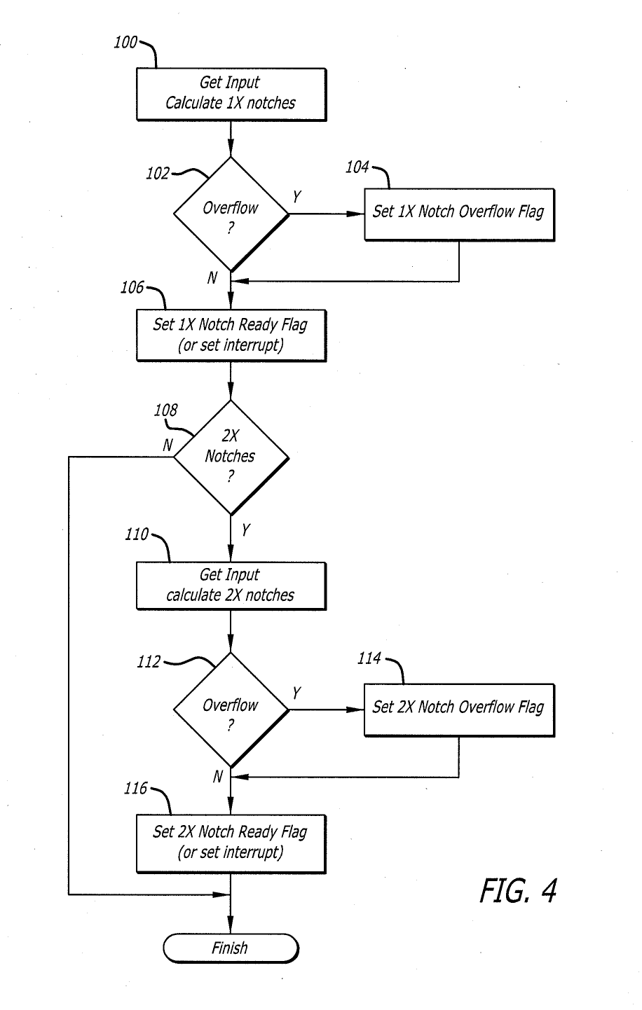

The notch filter engine 80 may perform notch filtering at different notches. For example, the engine 80 may perform notch filtering at 1×, 2×, 3× and 4×. The notch engine 80 may interact with the CPU 78 in the exemplary process shown in FIG. 4. In block 100 the notch engine calculates 1× notches. An overflow condition is determined in decision block 102. If there is an overflow an overflow flag is set in block 104. If there is no overflow, or after the overflow flag is set, a notch ready flag is set in block 106.

In decision block 108 it is determined whether the process is to calculate 2× notches. If not, the process is finished and the CPU 64 can utilize the 1× notch calculations. If yes, a process of calculating the 2× notches and setting overflow and notch ready flags is performed in blocks 110, 112, 114, and 116. When the process is completed the CPU can utilize the 1× and 2× notch calculations in a servo routine.

Providing a separate notch hardware engine reduces the overload on the CPU 78. The CPU load reduction also reduces the amount of memory and code required to perform a servo routine.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk that includes servo bits;
a head coupled to said disk;
an actuator arm coupled to said head;
a voice coil motor coupled to said actuator arm;
a central processing unit that performs a servo routine using said servo bits; and,
a notch hardware engine that is utilize by said central processing unit to perform a notch filter function in said servo routine.

2. The hard disk drive of claim 1, wherein said central processing unit and said notch hardware engine are on board a same chip.

3. The hard disk drive of claim 1, wherein said notch hardware engine performs a notch filter function for more than one notch.

4. The hard disk drive of claim 1, wherein said notch hardware engine generates a central processing unit interrupt after performing the notch filter function.

5. The hard disk drive of claim 1, wherein said notch hardware engine is an ASIC with add and multiplication elements.

6. A circuit for a hard disk drive that has a central processing unit, comprising:
a notch hardware engine that is utilize by the central processing unit to perform a notch filter function in a servo routine.

7. The circuit of claim 6, wherein said notch hardware engine performs a notch filter function for more than one notch.

8. The circuit of claim 6, wherein said notch hardware engine generates a central processing unit interrupt after performing the notch filter function.

9. The circuit of claim 6, wherein said notch hardware engine is an ASIC with add and multiplication elements.

10. A method for performing a servo routine a hard disk drive, comprising:
reading servo bits from a disk;
initiating a servo routine with the servo bits, the servo routine being performed by a central processing unit;
performing a notch filtering function in the servo routine with a notch hardware engine; and,
completing the servo routine with the notch filtering function.

11. The method of claim 10, further comprising generating an interrupt from the notch hardware engine to the central processing unit after the notch filtering function has been performed.

12. The method of claim 10, wherein the notch hardware engine performs a notch filter function for more than one notch.
